(19) United States
(12) Patent Application Publication
(10) Pub. No.: US 2010/0173561 A1
(43) Pub. Date: Jul. 8, 2010

(54) Crystal ball with dynamic audio and video (AV) effect

(76) Inventor: Chao-Hui Tseng, Hsichih City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 12/318,712

(22) Filed: Jan. 7, 2009

(51) Int. Cl. A63H 33/00; H04N 5/66

(52) U.S. Cl. 446/267; 348/739

(57) ABSTRACT

The present invention is to provide a crystal ball with dynamic audio and video (AV) effects, which is mainly composed of a crystal ball body and a base. The said crystal ball body has a transparent curtain cover with a bottom opening set inside it, and the base has a set of circuitry device with audio and video function set inside it. A display screen is set on top and can be set inside the transparent curtain cover. There are several operation and control buttons and audio source receiving and playing holes set on the base surface, and furthermore set with a memory card slot and a terminal seat that are capable of providing an insertion for the memory card or utilizing the terminal seat to insert the conduction wires then connect with the computer to proceed the load-in of images or pictures through these. And, it is able to record the songs or music through the audio source receiving and playing holes and it is also able to proceed the power on/off power, image display screen, video and audio playing or recording functions through the operation and control buttons to achieve the crystal ball to have the dynamic and variable video and audio demonstration and decoration functions.

### PRIOR ART OF THE INVENTION

The known crystal ball which acts as a decoration having its interior filled with transparent liquid generally will put modeling stuffs with fixed shape such as small bridges, pavilions or delicate buildings etc. three dimensional modeling stuffs inside the ball to buildup different atmospheres. However, no matter how elegant the modeling stuffs are put in, due to that the fixed shapes can not be changed at will, the irrevocable shapes will let the people feel boring and largely reduce their decorative effects after a period of time. It thus really requires to be improved.

### SUMMARY OF THE INVENTION

The present invention is to provide a crystal ball with dynamic audio and video (AV) effects. It is a decorative article with interesting effect and especially is indicating a crystal ball that acts as a decoration having its interior filled with transparent liquid and having a function capable of showing dynamic images.

### BRIEF DESCRIPTION OF THE DRAWINGS

FIG. 1 is a three-dimensional outside appearance diagram of the present invention.

FIG. 2 is a three-dimensional analytic diagram of the present invention.

### DETAILED DESCRIPTION OF THE PREFERRED EMBODIMENT

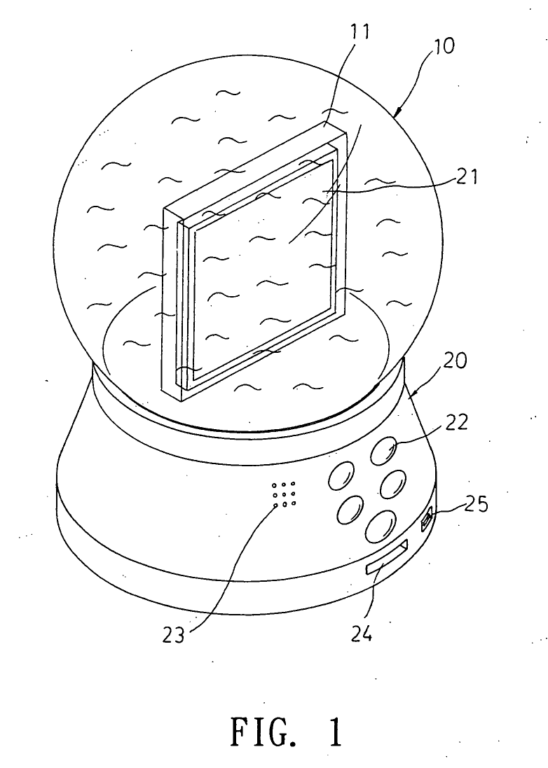

The present invention is to provide a crystal ball with dynamic audio and video (AV) effects as FIG. 1, which is mainly composed of a crystal ball body 10 and a base 20. Wherein, a transparent curtain cover 11 with water-separation function and with a bottom opening is set inside the crystal ball body 10, and a set of circuitry device with audio and video function (not shown in the figure) is set inside the base 20. A display screen is set on top and able to be laid inside the transparent curtain cover 11. Several operation and control buttons 22 and audio source receiver and player 23 are set on the base 20 surface. Furthermore, it is set with a memory card slot 24 and a terminal seat 25. And, the display screen 21, operation and control buttons 22, audio source receiver and player 23, memory card slot 24 and terminal seat 25 are all conductively connected with the video and audio functional circuitry device and controlled.

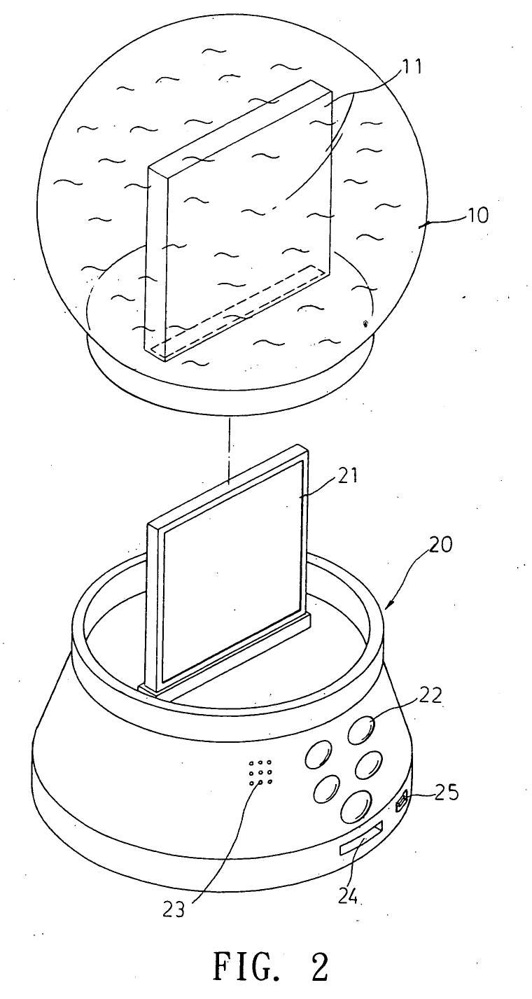

Please cooperate with the FIG. 2. The present invention is to integrate the crystal ball body 10 on the base 20 such that the image display screen 21 is laid inside the transparent curtain cover 11. It can utilize the terminal seat 25 to be inserted a conductive wire and connect with the computer. The computer is used to perform the editing of images or pictures then transfer them to the video and audio functional circuitry device or store them in the memory card. And, through the operation and control of the audio source receiver and player 23 and operation and control buttons 22, it can receive and record the speech sound or special music directly on the spot. And the said several operation and control buttons 22 can control the functions of power on/off of the base 20, image switching of the display screen and the audio source switching. Furthermore, it can also insert the memory cards that have already been loaded-in different video-audio then use the operation and control buttons 22 to proceed the playing of different video-audio.

Through this design, it can let the crystal ball have the dynamic and replaceable video and audio functions such that the decorated crystal ball can further increase its interesting effect and further underline the decoration effect. It thus is really a new type of design with innovation and progressiveness.

I claim:

1. A crystal ball with dynamic audio and video (AV) effects mainly including a crystal ball body and a base, having a transparent curtain cover with water-separation function and with a bottom opening set inside the said crystal ball body, having a set of circuitry device with audio and video function set inside the base, and having a display screen set on top being able to be laid inside the transparent curtain cover for the playing of dynamic images.

2. A crystal ball with dynamic audio and video (AV) effects as claimed in claim 1, wherein several operation and control buttons and audio source receiving and playing holes are set on the base surface, furthermore it is set with a memory card slot and a terminal seat, and the display screen, operation and control buttons, audio source receiver and player, memory card slot and terminal seat are all conductively connected with the video and audio functional circuitry device and can be controlled.
